(19) United States
(12) Patent Application Publication
(10) Pub. No.: US 2003/0197675 A1
(43) Pub. Date: Oct. 23, 2003

(54) Display control apparatus and display control method

(75) Inventor: Takashi Sakurai, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/359,068

(22) Filed: Feb. 6, 2003

(30) Foreign Application Priority Data
Apr. 17, 2002 (JP) 2002-114975

(51) Int. Cl. G09G 3/36

(52) U.S. Cl. 345/102; 345/204

(57) ABSTRACT

A light management utility program provides a user interface for setting an angle at which a display surface of a reflection-type LCD is inclined in use relative to a line of view of a user. If the user interface has determined that the LCD is used in such a state that an upper part of the display surface is positioned backward and a lower part of the display surface is positioned forward, the light management utility program, for example, turns off those front lights arranged on the lower part, which are useless in such a condition of use. In this manner, the turn-on of front lights is properly controlled in accordance with the angle between the display surface of the LCD and the line of view of the user. Hence, the power consumption is greatly reduced.

### CROSS-REFERENCE TO RELATED APPLICATIONS

This application is based upon and claims the benefit of priority from the prior Japanese Patent Application No. 2002-114975, filed Apr. 17, 2002, the entire contents of which are incorporated herein by reference.

### BACKGROUND OF THE INVENTION

1. Field of the Invention

The present invention relates generally to a display control apparatus and a display control method which control driving of a display device such as a reflection-type Liquid Crystal Display (LCD), and more particularly to a display control apparatus and a display control method which can properly control turn-on of a light for illuminating a display screen of the display device and can greatly reduce a power consumption of the display device.

2. Description of the Related Art

In recent years, LCDs have widely been used as display devices of various kinds of apparatuses, such as mobile phones and notebook-type personal computers. The LCD requires lights for illuminating a display panel. According to the arrangement of lights, LCDs fall into two types: transmission-type LCDs and reflection-type LCDs.

In the transmission-type LCD, the lights are disposed such that they illuminate a display panel from the back side of the LCD. On the other hand, in the reflection-type LCD, the lights are disposed such that they illustrate a display panel from the front side of the LCD.

In the case of the reflection-type LCD, in general, a plurality of lights are arranged in the vicinity of the periphery of the display panel in a distributed fashion. Light is radiated on the display panel from the lights, and the reflection light is directed to the user. However, all reflection light reaches the user only when the display panel is positioned substantially perpendicular to the line of vision of the user. For example, when the upper side of the display panel is turned rearward, there may be a case where the reflection light of the lights disposed at the lower part of the display panel do not reach the user.

Even in such an undesirable case, if an external power is supplied via an AC line, etc., no serious problem would arise. However, in a battery-driven mode, the power is limited and the limited power is wastefully consumed. Consequently, the operation time of the electronic apparatus would disadvantageously be shortened.

### BRIEF SUMMARY OF THE INVENTION

One embodiment of the invention may provide a display control apparatus and a display control method capable of properly controlling turn-on of lights for illuminating a display screen of a display device, and greatly reducing a power consumption of the display device.

According to an aspect of the present invention, it may provide a display control apparatus comprising: a display device having at least one light for illuminating a display screen of the display device; a determination unit configured to determine an angle between the display screen and a line of view when the display screen of the display device is viewed; and a control unit configured to control turn-on/off of the light on the basis of a determination result of the determination unit.

According to another aspect of the present invention, it provides a display control method for a display device having at least one light for illuminating a display screen of the display device, comprising: determining an angle between the display screen and a line of view when the display screen of the display device is viewed; and controlling turn-on/off of the light on the basis of a determination result of the determination step.

According to another aspect of the present invention, it provides a display control apparatus comprising: a display device having a plurality of lights for illuminating a display screen of the display device; a determination unit configured to determine a display area on the display screen of the display device; and a control unit configured to control turn-on/off of the lights on the basis of a determination result of the determination unit.

According to another aspect of the present invention, it provides a display control method for a display device having a plurality of lights for illuminating a display screen of the display device, comprising: determining a display area on the display screen; and controlling turn-on/off of the lights on the basis of a determination result of the determination step.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an external appearance of an information processing apparatus according to an embodiment of the present invention;

FIG. 2 shows arrangement of front lights associated with the LCD of the information processing apparatus of the embodiment;

FIG. 3 is a conceptual view illustrating how light is radiated on the display surface of the LCD from the front light of the information processing apparatus of the embodiment;

FIG. 4A and FIG. 4B are views for explaining how the relationship between the display surface of the LCD and the line of view of the user affects the illumination of each front light in the information processing apparatus of the embodiment;

FIG. 5 shows a hardware configuration of the information processing apparatus according to the embodiment;

FIG. 6 shows a software configuration of the information processing apparatus according to the embodiment;

FIG. 7 is a first view for describing a user interface provided by a light management utility program of the information processing apparatus according to the embodiment;

FIG. 8 is a second view for describing the user interface provided by the light management utility program of the information processing apparatus according to the embodiment;

FIG. 9 is a flow chart illustrating an operational procedure of a front light turn-on control executed by the information processing apparatus of the embodiment;

FIG. 10 is a view for describing an example of a front light turn-on control in association with the display area on the display screen of the LCD in the information processing apparatus of the embodiment;

FIG. 11 shows an example of control information stored on a setting table of the information processing apparatus of the embodiment; and

FIG. 12 is a flow chart illustrating an operational procedure of a front light turn-on control (applied example) executed by the information processing apparatus of the embodiment.

### DETAILED DESCRIPTION OF THE INVENTION

An embodiments of the present invention will now be described with reference to the accompanying drawings.

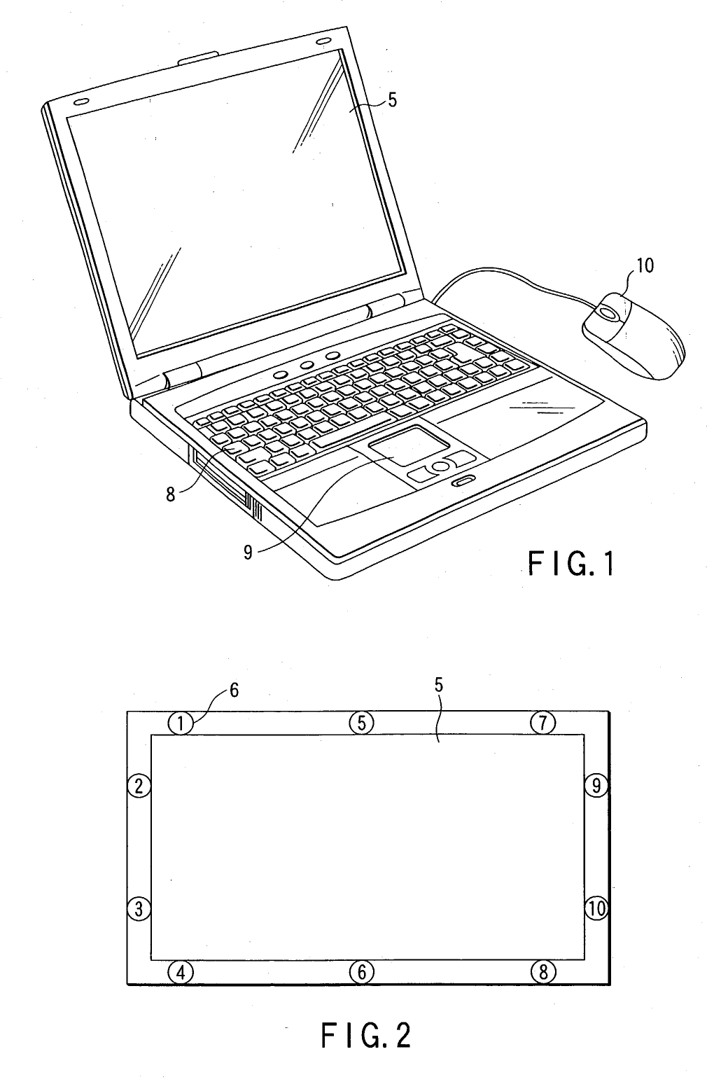

FIG. 1 shows an external appearance of an information processing apparatus according to the embodiment of the present invention. As is shown in FIG. 1, this information processing apparatus is a notebook-type personal computer having a cover. An LCD 5 is disposed on the inside of the cover. The LCD 5 is of a so-called reflection type. A plurality of lights (front lights) for illuminating the display surface are arranged around a peripheral portion of the LCD 5 in a distributed fashion.

A keyboard 8 and a touch panel 9 are provided on the main body that is opposed to the cover. In addition, a mouse 10 for pointing a given location on the LCD 5, like the touch pad 9, may be connected, if necessary, to the main body of the information processing apparatus.

FIG. 2 shows arrangement of front lights associated with the LCD 5 of the information processing apparatus of this embodiment. As is shown in FIG. 2, ten front lights 6, which are numbered from “1” to “10”, are arranged so as to surround the display surface of the LCD 5.

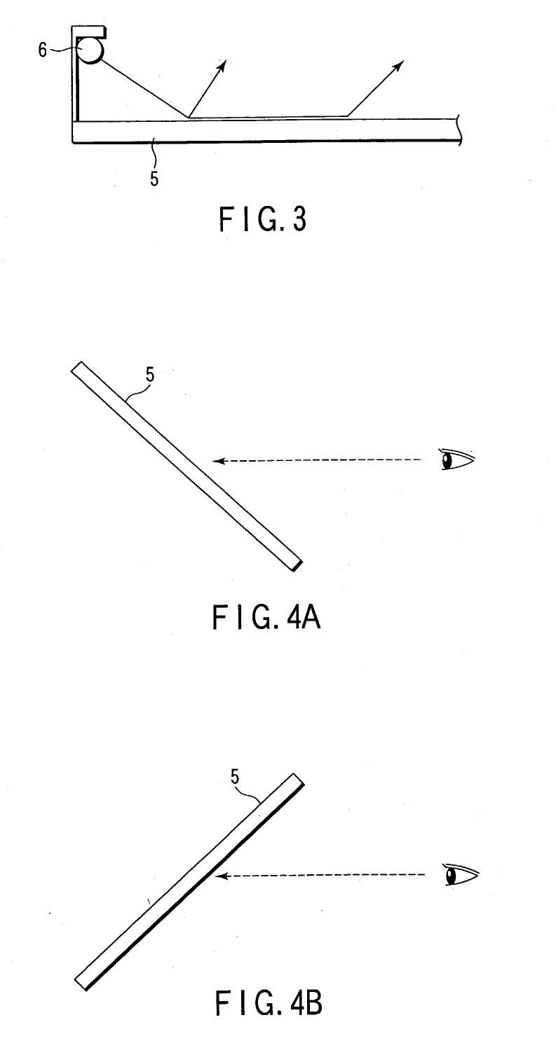

FIG. 3 is a conceptual view illustrating how light is radiated on the display surface of the LCD from the front lights of the information processing apparatus of the embodiment. As is shown in FIG. 3, each front light 6 is fixed at a height of, e.g. 0.5 mm, at a peripheral portion of the LCD 5. Light emitted from the front light 6 is reflected by the display surface of the LCD 5, and the reflected light is directed to the user.

Referring to FIG. 4A and FIG. 4B, a description will now be given of how the relationship between the display surface of the LCD 5 and the line of view of the user affects the illumination of each front light 6.

FIG. 4A illustrates a case where the LCD 5 is used in such a state that the upper part of the display surface of LCD 5 is positioned backward and the lower part of the display part is positioned forward. In this case, the light that is emitted from the front lights 6 arranged on the upper part of the display surface, i.e. the first, fifth and seventh front lights 6 in FIG. 2, and reflected by the display surface is usefully directed to the user. On the other hand, the light that is emitted from the front lights 6 arranged on the lower part of the display surface, i.e. the fourth, sixth and eighth front lights 6 in FIG. 2, and reflected by the display surface is not directed to the user and useless.

FIG. 4B illustrates a case where the LCD 5 is used in such a state that the upper part of the display surface of LCD 5 is positioned forward and the lower part of the display part is positioned backward. In this case, contrary to the above, the light that is emitted from the front lights 6 arranged on the upper part of the display surface, i.e. the first, fifth and seventh front lights 6 in FIG. 2, and reflected by the display surface is not directed to the user and useless. The light that is emitted from the front lights 6 arranged on the lower part of the display surface, i.e. the fourth, sixth and eighth front lights 6 in FIG. 2, and reflected by the display surface is usefully directed to the user.

As has been described above, in the case of the reflection-type LCD 5, the useful/useless illumination by the front lights 6 arranged on the peripheral portion of the display surface varies depending on the condition of use. The information processing apparatus according to this embodiment has a structural feature for properly controlling turn-on of the front lights 6 and realizes remarkable reduction in power consumption of the front lights 6. This feature will now be described in detail.

FIG. 5 shows a hardware configuration of the information processing apparatus according to the embodiment.

As is shown in FIG. 5, the information processing apparatus comprises the LCD 5, front lights 6, keyboard 8, touch pad 9 and mouse 10 (these are shown in FIGS. 1 and 2). This apparatus also comprises a CPU 1, a RAM 2, a hard disk drive 3, a display controller 4 and a keyboard controller 7.

The CPU 1 controls the entirety of the information processing apparatus. The CPU 1 operates according to various programs stored in the RAM 2, such as an operating system, a utility program and an application program. The RAM 2 is a main memory of the information processing apparatus. The RAM 2 stores various programs describing the operational procedures of the CPU 1, and various data input to and output from these programs. On the other hand, the hard disk drive 3 is an external memory device of the information processing apparatus. The hard disk drive 3 stores a great deal of programs and data as a lower-level device of the RAM 2.

The display controller 4 controls the output of a user interface of the information processing apparatus. The display controller 4 enables the LCD 5 to display image data generated by the CPU 1, and controls turn-on of the front lights for illuminating the display surface of the LCD 5. The keyboard controller 7 controls the input of the user interface of the information processing apparatus. The keyboard controller 7 tells the operations of the keyboard 8, touch pad 9 and mouse 10 to the CPU 1.

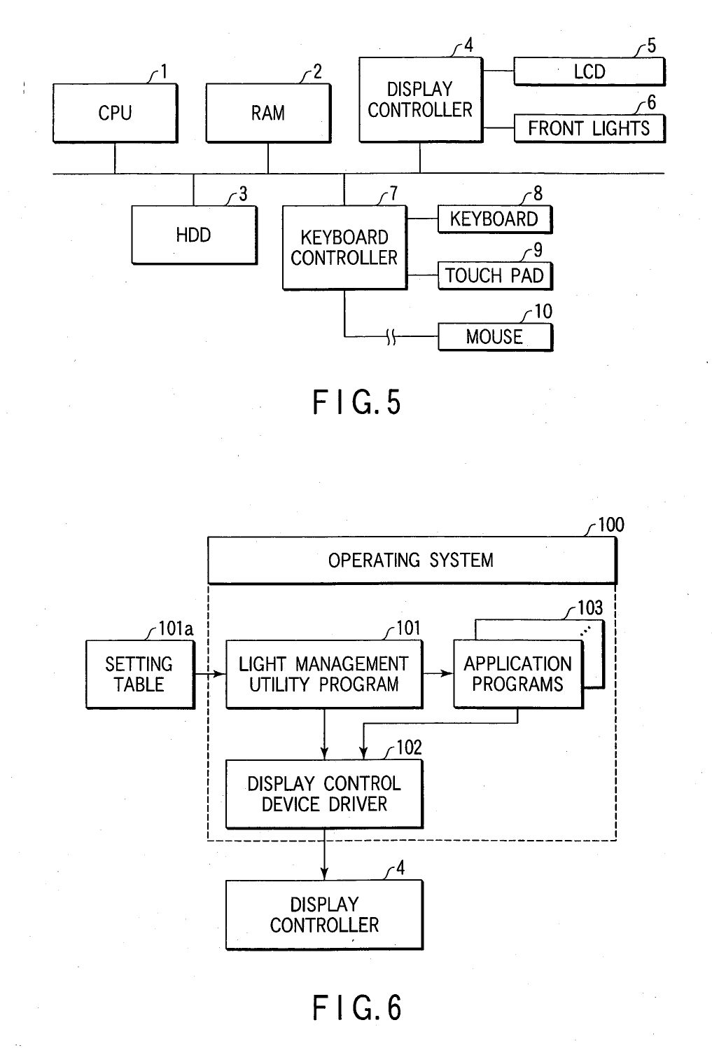

FIG. 6 shows a software configuration of the information processing apparatus according to the embodiment.

As is shown in FIG. 6, in this information processing apparatus, a light management utility program 101, a display control device driver 102 and various application programs 103 are activated under control of an operating system 100.

The light management utility program 101 is a program that realizes a turn-on control for the front lights 6. The turn-on control characterizes the information processing apparatus of this embodiment. The light management utility program 101 provides a user interface for performing various settings relating the LCD 5. Based on the settings, this program drives the display controller 4 using the display control device driver 102, and controls turn-on of the front lights 6. In addition, the light management utility program 101 has a setting table 101a for storing contents set by the user. The setting table 101a prestores control information indicating how the front lights 6 should be turned on in accordance with the user-set contents.

The display control device driver 102 interfaces the application program 103 and the LCD 5 so that the application program 103, which is software, can make use of the LCD 5 which is hardware. The display control device controller 102 controls the display of the image generated by the application program 103 on the LCD 5. The application programs are so-called business programs used by the user, as desired, which include word processing software and spreadsheet program software.

The principle of operations of the turn-on control for the front lights 6, which is executed by the information processing apparatus, will now be described. The condition of use of LCD 5 is specified by angles in use, that is, “135°”, as shown in FIG. 4A, “90°” at which LCD 5 is vertically upright, and “45°”, as shown in FIG. 4B.

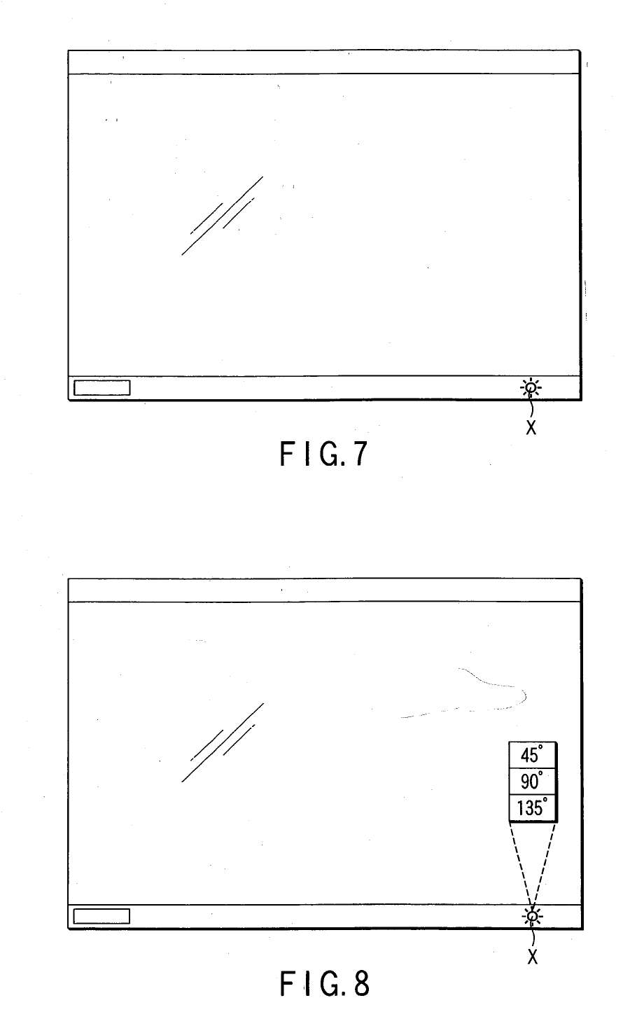

In order to set the condition of use, the light management utility program 101 displays a special task bar X at the lower side of the display screen, for example, as shown in FIG. 7. FIG. 7 is a view for describing a user interface provided by the light management utility program 101.

The task bar X is activated by “clicking” by means of, e.g. the mouse 10. If the task bar X is clicked, the light management utility program 101 displays “45°”, “90°” and “135°” as choices. FIG. 8 shows an example of a display image in this case. Assume that “90°” is initially set as the condition of use of LCD 5.

Then, assume that the user intends to change the condition of use of LCD 5 from “90°” to “45°”. In this case, the user clicks the task bar X and then clicks “45°” by means of, e.g. the mouse 10. If this re-setting operation is effected, the light management utility program 101 stores the setting content in the setting table 101a. The light management utility program 101 refers to the control information in the setting table 101a in order to determine how to turn on the front lights 6 in accordance with the setting content. Thus, the light management utility program 101 controls the turn-on of the front lights 6.

More specifically, when the condition of use is set at, e.g. “45°”, the control information indicates that the first, fifth and seventh front lights 6 in FIG. 2 are turned off and the other front lights 6 are turned on. When the condition of use is set at “90°”, the control information indicates that all the first to tenth front lights 6 in FIG. 2 are turned on. When the condition of use is set at, e.g. “135°”, the control information indicates that the fourth, sixth and eighth front lights 6 in FIG. 2 are turned off and the other front lights 6 are turned on. Upon the re-setting of the user, the light management utility program 101 drives the display controller 4 using the display control device driver 102 so that the first, fifth and seventh front lights 6 in FIG. 2 are turned off and the other front lights 6 are turned on.

According to the light management utility program 101, the turn-on of front lights 6 is properly controlled, for example, by turning off some front lights 6 which become useless depending on the angle between the display surface of LCD 5 and the line of view of the user. Therefore, the power consumption can remarkably be reduced.

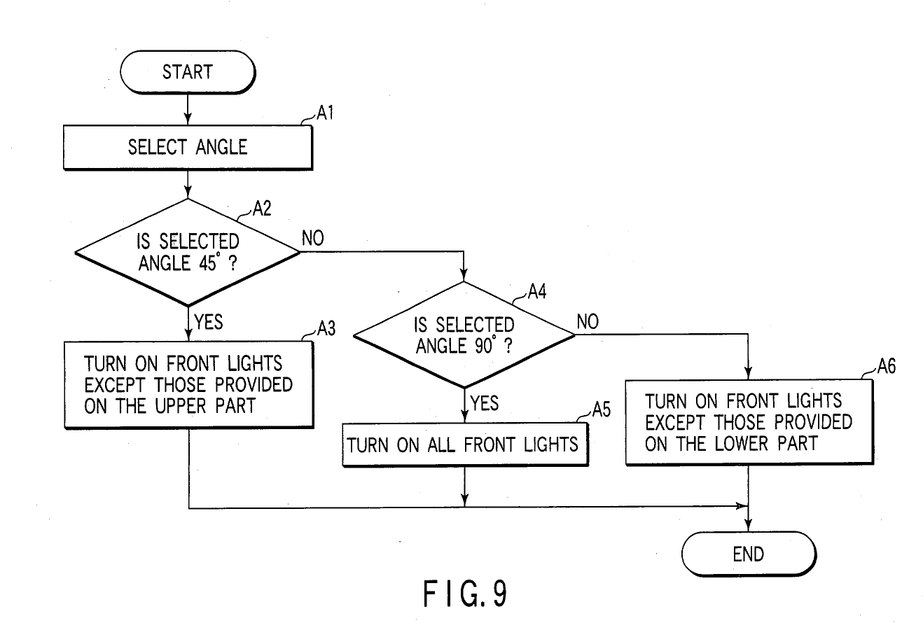

Referring now to FIG. 9, a description will be given of the operational procedure of the turn-on control for front lights 6, which is executed by the information processing apparatus.

To start with, the angle of the display surface of the LCD 5 is selected (step A1). If the selected angle is 45° (YES in step A2), the light management utility program 101 turns on the front lights 6 except those arranged on the upper side of the display surface (step A3). If the selected angle is 90° (NO in step A2, YES in step A4), the light management utility program 101 turns on all the front lights 6 (step A5). If the selected angle is the other choice, i.e. 135° (NO in step A2, NO in step A4), the light management utility program 101 turns on the front lights 6 except those arranged on the lower side of the display surface (step A6).

In the above example, the turn-on control for the front lights 6 is effected by turning on/off the lights 6. Alternatively, the turn-on control may be effected by increasing/decreasing the luminance. Thereby, the angle can be set more finely among a greater number of choices.

In the above example, the user clicks the task bar X, thereby setting the condition of use of LCD 5. Alternatively, for example, a hinge mechanism section that rotatably couples the cover and the main body of the information processing apparatus may be provided with a sensor for sensing the angle between the cover and the main body. Thereby, the condition of use of LCD 5 may automatically be detected.

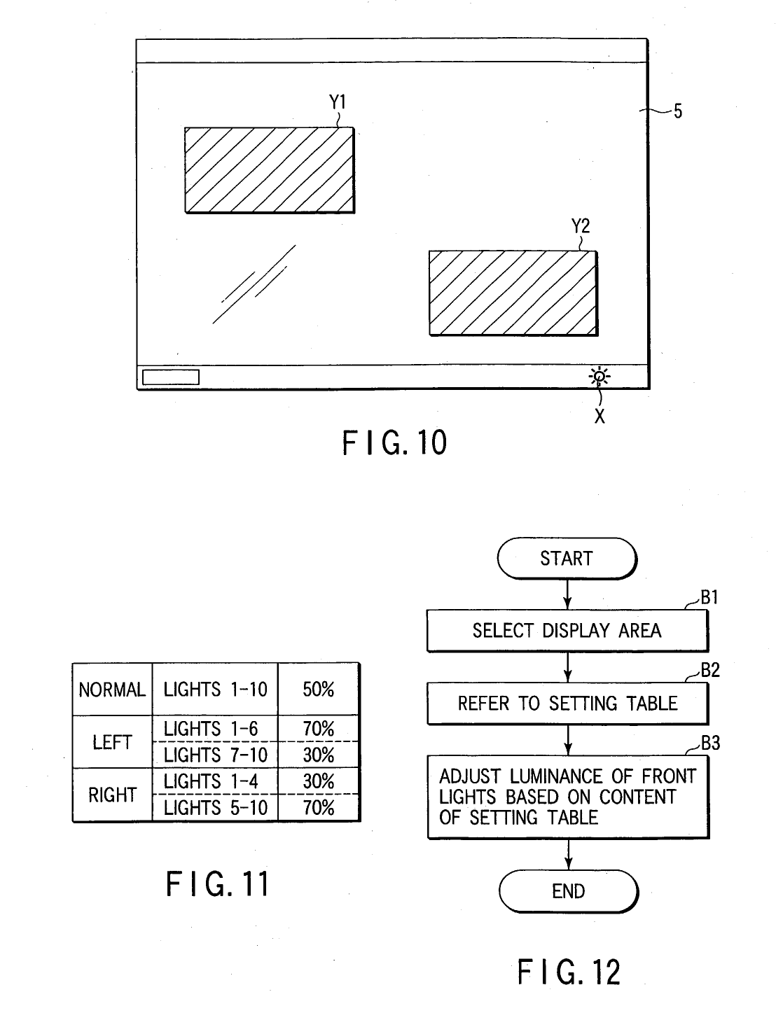

The above method for controlling the turn-on of front lights 6 based on the condition of use is applicable not only to the mode based on the angle between the display surface of LCD 5 and the line of view of the user, but also to various modes. Referring to FIGS. 10 and 11, a description will now be given of an example of turn-on control of front lights 6 in association with display areas on the display surface of LCD 5.

For example, when a display area Y1 on the display surface of LCD 5 is mainly used, the right-side area of the display screen does not need a high luminance. On the other hand, if a display area Y2 is mainly used, the left-side area of the display screen does not need a high luminance. In this example, control information as shown in FIG. 11 is stored in the setting table 101a and the turn-on of the front lights 6 is controlled according to the user's selection operations.

More specifically, when the task bar X has been clicked by means of, e.g. the mouse 10 and “NORMAL” has been selected, all the front lights 6 are turned on with a normal luminance (50%). If “LEFT” has been selected, the first to sixth front lights 6 in FIG. 2 are turned on with a high luminance (70%) and the seventh to tenth front lights 6 are turned on with a low luminance (30%). If “RIGHT” has been selected, the first to fourth front lights 6 in FIG. 2 are turned on with a low luminance (30%) and the fifth to tenth front lights 6 are turned on with a high luminance (70%).

In short, the turn-on of the front lights 6 is properly controlled according to the condition of use of the display area on the display surface of LCD 5. Thus, like the above-described example, the power consumption can remarkably be reduced.

FIG. 12 is a flow chart illustrating an operational procedure of the front light turn-on control executed by the information processing apparatus.

If a display area on the display surface of LCD 5 is selected (step B1), the light management utility program 101 refers to the control information stored in the setting table 101a (step B2). Based on the control information, the luminance of front lights 6 is adjusted in accordance with the selected display area (step B3).

In this example, the light turn-on control method is effective both for reflection-type LCDs and transmission-type LCDs.

In this example, the user clicks the task bar X to select the display area. Alternatively, the display area can automatically be detected, for instance, by obtaining information on the area for the display processing from the display controller 4, or obtaining information on an active window area from the operating system 100.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display control apparatus comprising:
a display device having at least one light for illuminating a display screen of the display device;
a determination unit configured to determine an angle between the display screen and a line of view when the display screen of the display device is viewed; and
a control unit configured to control turn-on/off of the light on the basis of a determination result of the determination unit.

2. The display control apparatus according to claim 1, wherein the at least one light includes a plurality of lights.

3. The display control apparatus according to claim 1, wherein the control unit controls the turn-on/off of the light by turning on/off the light.

4. The display control apparatus according to claim 1, wherein the control unit controls the turn-on/off of the light by changing a luminance of the light.

5. The display control apparatus according to claim 1, further comprising a memory unit which store control information that associates the angle between the display screen and the line of view with a desired turn-on/off state of the light,
wherein the control unit refers to the control information stored in the memory unit and executes a turn-on/off control for the light on the basis of the determination result of the determination unit.

6. A display control apparatus comprising:
a display device having a plurality of lights for illuminating a display screen of the display device;
a determination unit configured to determine a display area on the display screen of the display device; and
a control unit configured to control turn-on/off of the lights on the basis of a determination result of the determination unit.

7. The display control apparatus according to claim 6, wherein the control unit controls the turn-on/off of the lights by turning on/off the lights.

8. The display control apparatus according to claim 6, wherein the control unit controls the turn-on/off of the lights by changing a luminance of the lights.

9. The display control apparatus according to claim 6, further comprising a memory unit which store control information that associates the display area on the display screen with a desired turn-on/off state of the lights,
wherein the control unit refers to the control information stored in the memory unit and executes a turn-on/off control for the lights on the basis of the determination result of the determination unit.

10. A display control method for a display device having at least one light for illuminating a display screen of the display device, comprising:
determining an angle between the display screen and a line of view when the display screen of the display device is viewed; and
controlling turn-on/off of the light on the basis of a determination result of the determination step.

11. The display control method according to claim 10, wherein the control step controls the turn-on/off of the light by turning on/off the light.

12. The display control apparatus according to claim 10, wherein the control step controls the turn-on/off of the light by changing a luminance of the light.

13. A display control method for a display device having a plurality of lights for illuminating a display screen of the display device, comprising:
determining a display area on the display screen; and
controlling turn-on/off of the lights on the basis of a determination result of the determination step.

14. The display control method according to claim 13, wherein the control step controls the turn-on/off of the lights by turning on/off the lights.

15. The display control apparatus according to claim 13, wherein the control step controls the turn-on/off of the lights by changing a luminance of the lights.
